(19) United States
(12) Patent Application Publication
(10) Pub. No.: US 2026/0170607 A1
(43) Pub. Date: Jun. 18, 2026

(54) METHOD FOR REMOVING SHADING OF AN IMAGE AND ELECTRONIC DEVICE

(71) Applicant: TP-Link Systems Inc., IRVINE, CA (US)

(72) Inventor: Wenjun Zhang, Shenzhen (CN)

(73) Assignee: TP-Link Systems Inc., IRVINE, CA (US)

(21) Appl. No.: 18/984,800

(22) Filed: Dec. 17, 2024

(51) Int. Cl. G06T 5/20; G06T 3/4046; G06T 5/60; G06V 10/44; G06V 10/77; G06V 10/82

(52) U.S. Cl. CPC G06T 5/20; G06T 3/4046; G06T 5/60; G06V 10/443; G06V 10/7715; G06V 10/82; G06T 2207/20016; G06T 2207/20081; G06T 2207/20084

(57) ABSTRACT

The present disclosure provides a method for removing shading of an image, including: acquiring an original image having a shading; and inputting the original image into a trained shading removing neural network to obtain a shading removed image corresponding to the original image, wherein the shading removing neural network including: an image decomposition unit, configured to decompose the original image into a low-frequency component and a set of high-frequency component using Laplacian Pyramid Mechanism; a low-frequency subnetwork, configured to generate a shading removed low-frequency component based on the low-frequency component; a high-frequency subnetwork, configured to generate a set of shading removed high-frequency component based on the shading removed low-frequency component and the set of high-frequency component; and an image synthesis unit, configured to generate the shading removed image by synthesizing the shading removed low-frequency component and the set of shading removed high-frequency component using the Laplacian Pyramid Mechanism.

### TECHNICAL FIELD

The present disclosure relates to the field of artificial intelligence services, and more particularly to a method for removing shading of an image, an electronic device for performing the method.

### BACKGROUND

With the popularity of e-commerce, telecommuting and online education, there is an increasing demand for the use of image capture devices such as cameras to capture and transmit images of documents (hereinafter referred to as images). These images may comprise, for example, resumes, meeting materials, electronic invoices, etc. However, due to the influence of the lighting of the environment used for photographing, the photographed images are likely to have shading that affects the visual quality and readability of the images.

Existing methods for removing the shading from such images are basically designed for low resolution images and therefore cannot retain high resolution image details that are critical for recognizing the content of the images, making it difficult to process images captured by high resolution cameras. In addition, the computing and/or storage resources of the image capture devices are often limited, requiring a lightweight shading removal method designed to run on the image capture device. However, existing machine learning models are inherently complex and difficult to deploy on image capture devices.

### SUMMARY

In view of the above problems, the present disclosure provides techniques for removing shading of an image and an electronic device for performing the method.

According to an aspect of the present disclosure, there is provided a method for removing shading of an image. The method comprises: acquiring an original image having shading; and removing the shading of the original image with a trained shading removing neural network to obtain a shading removed image corresponding to the original image, wherein the shading removing neural network comprises: an image decomposition unit configured to decompose the original image into a low-frequency component and a set of high-frequency components using the Laplacian Pyramid Mechanism; a low-frequency subnetwork configured to generate a shading removed low-frequency component based on the low-frequency component; a high-frequency subnetwork configured to generate a set of shading removed high-frequency components based on the shading removed low-frequency component and the set of high-frequency components; and an image synthesis unit configured to generate the shading removed image by synthesizing the shading removed low-frequency component and the set of shading removed high-frequency components according to the Laplacian Pyramid Mechanism.

According to an aspect of the present disclosure, there is provided an electronic device. The electronic device comprises one or more processors and one or more memories, wherein the one or more memories have computer-executable instructions therein which, when executed by the one or more processors, cause the one or more processors to perform the method described above.

According to yet another aspect of the present disclosure, there is provided a computer program product. The computer program product comprises a computer readable storage medium having computer-executable instructions therein which, when executed by a processor, cause the processor to perform the method described above.

The embodiments of the present disclosure may use a shading removing neural network to remove the shading of images. The shading removing neural network combines Laplacian pyramids into the image processing workflow. In this way, a lightweight shading removing neural network can be achieved, the high-resolution details of the images can be retained and the image features can be analyzed across various resolutions. Meanwhile, the shading removing neural network separately removing the shading of the low-frequency component and high-frequency component. This allows for improved overall feature extraction and learning efficiency and the reduced computational complexity reduced. The shading removal method according to the embodiments of the present disclosure can be deploy and run on the image capture devices.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure but do not constitute a limitation on the present disclosure. In the drawings, unless otherwise explicitly indicated, the same reference numerals refer to the same components, steps or elements.

FIG. 1 is a diagram illustrating an exemplary application scenario of the method for removing shading from an image according to an embodiment of the present disclosure;

FIG. 2 is a diagram illustrating an exemplary architecture for the shading removing neural network according to an embodiment of the present disclosure;

FIG. 3 is a diagram illustrating an example of the Laplacian pyramid mechanism;

FIG. 4 is a diagram illustrating the example image components obtained by the image decomposition unit according to the present disclosure;

FIG. 5 is a diagram illustrating an exemplary architecture of a low frequency sub-network according to an embodiment of the present disclosure;

FIG. 6 is a diagram illustrating an exemplary workflow of the attention alignment module according to an embodiment of the present disclosure;

FIG. 7 is a diagram illustrating an exemplary architecture of a high-frequency subnetwork according to an embodiment of the present disclosure;

FIG. 8 is a diagram illustrating an exemplary architecture of the mask generation module according to an embodiment of the present disclosure;

FIG. 9 is a diagram illustrating an exemplary architecture of the high-frequency feature extraction module according to an embodiment of the present disclosure;

FIG. 10 is a diagram illustrating the example shading removed image obtained by the image synthesis unit according to the present disclosure;

FIG. 11 is a diagram illustrating the flowchart of the method for removing shading of an image according to an embodiment of the present disclosure;

FIG. 12 is diagram illustrating a test result according to an embodiment of the present disclosure; and

FIG. 13 is an exemplary block diagram illustrating the electronic device according to an embodiment of the present disclosure.

### DETAILED DESCRIPTION

The technical solution of the present disclosure will be clearly and completely described below in conjunction with accompanying drawings. The described embodiments are part of embodiments of the present disclosure, but not all of them. Based on the embodiments in the present disclosure, all other embodiments acquired by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit but represent an existence of at least one. Words like “comprise” or “comprise” mean that an element or an object in front of the said word encompasses those ones listed following the said word and their equivalents, without excluding other elements or objects. Words like “connect” or “link” are not limited to physical or mechanical connections, but may comprise electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined as long as no conflicts occur therebetween.

Some of the drawings may not depict all the components of a given method, device and system. Like reference numerals may be used to denote like features throughout the specification and drawings.

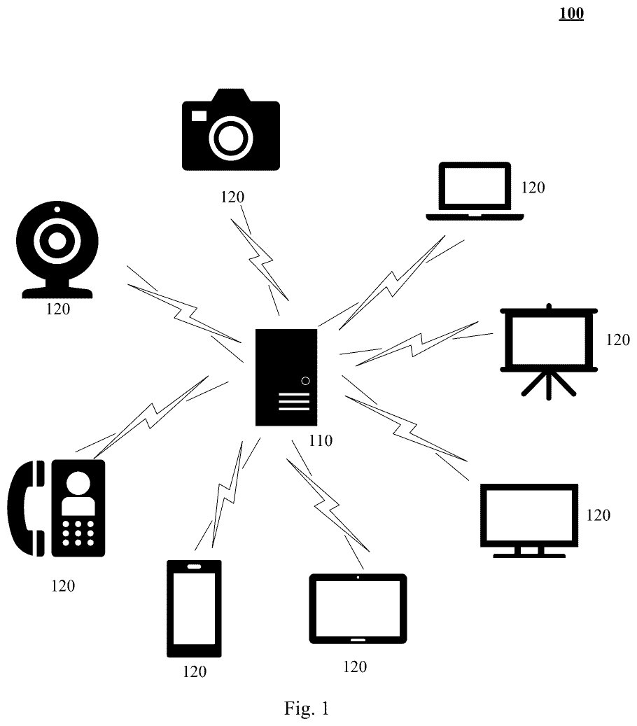

FIG. 1 is a diagram illustrating an exemplary application scenario of the method for removing shading from an image according to an embodiment of the present disclosure.

Referring to FIG. 1, an application scenario 100 according to an embodiment of the present disclosure may comprise a server 110 and a plurality of terminal electric devices 120 connected to the server 110 via a network (such as, wide area network (WAN), local area network (LAN), personal area network (PAN), etc.). The shading removing neural network 200 according to the embodiment of the present disclosure may be deployed on each of the plurality of terminal electric devices 120. The terminal electric device 120 may capture an original image having shading or receive the original image from other image capturing devices via a communication network, and then remove the shading of the original image with the shading removing neural network 200 to obtain a shading removed image corresponding to the original image. Each of the plurality of terminal electric devices 120 may be any electronic device, such as a camera, a notebook, a desktop computer, a projector, a tablet, a mobile phone, a smart speaker or a smart watch, etc., which is not limited in this disclosure. The server 110 may be an independent physical server, a server cluster or distributed system including a plurality of physical servers, or a cloud server that provides a cloud computing service. The server 110 and each of the plurality of terminal electric devices 120 may be directly or indirectly connected via wired or wireless communication, which is not limited in the present disclosure.

The application of neural networks has become an important breakthrough in the field of image processing. However, the technique of removing the shading from images still faces many challenges. As mentioned above, existing methods for removing shading from images are basically designed for low resolution images, and thus cannot retain the high-resolution details of the images that are critical for recognizing the content of the images. This makes it difficult to process the images captured by the high resolution cameras. The high resolution can improve image details, but it can also amplify the noise in the images, especially in a low illumination environment, making it more difficult to recognize the shading areas of the images.

To handle more challenging photography conditions, such as high resolution and low illumination conditions, the present disclosure proposes an image shading removing technique that can effectively remove the shading of the image while retaining high resolution details of images.

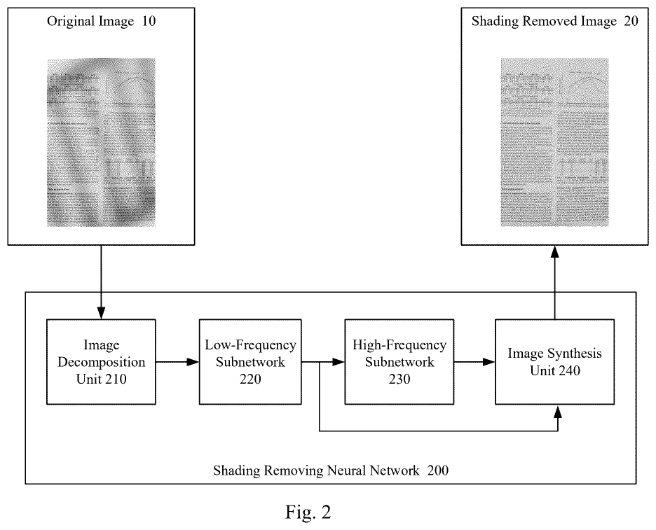

FIG. 2 is a diagram illustrating an exemplary architecture for the shading removing neural network according to an embodiment of the present disclosure.

Referring to FIG. 2, the shading removing neural network 200 may comprise an image decomposition unit 210, a low-frequency subnetwork 220, a high-frequency subnetwork 230 and an image synthesis unit 240. The input of an original image 10 with shading to the shading removing neural network 220 may result in the output of a shading removed image 20 corresponding to the original image 10.

The image decomposition unit 210 may decompose the original image 10 having shading into a low-frequency component and a set of high-frequency components according to Laplacian pyramid mechanism. The low-frequency subnetwork 220 may generate a shading removed low-frequency component based on the low-frequency component. For each of the set of high-frequency components, the high-frequency subnetwork 230 may generate the corresponding shading removed high-frequency component based on the high-frequency component and the shading removed low-frequency component. The image synthesis unit 240 may generate the shading removed image by synthesizing the shading removed low-frequency component and the set of shading removed high-frequency components according to the Laplacian pyramid mechanism.

Compared to traditional neural network-based image shading removal methods, the shading removing neural network 200 according to an embodiment of the present disclosure combines Laplacian pyramids into the image processing workflow. The Laplacian pyramids represent a series of images at different resolution scales, enabling the shading removing neural network 220 to analyze them at different resolution scales, which leads to richer feature extraction and greater accuracy in image recognition. This structure also allows the shading removing neural network 220 to process images layer by layer across resolution scales, reducing computational complexity and enhancing adaptability, especially at high resolutions. Additionally, the shading removing neural network 220 may separately process the low-frequency and the set of high-frequency components using the low-frequency subnetwork 220 and the high-frequency subnetwork 230. This enables focused detail restoration in the high-frequency areas, improving the overall effect of the shading removal.

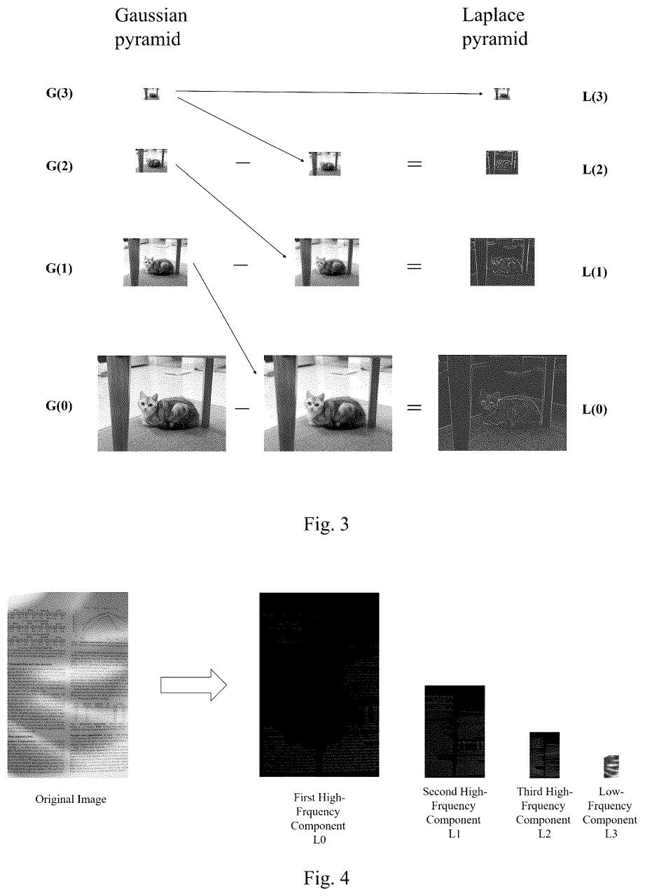

FIG. 3 is a diagram illustrating an example of the Laplacian pyramid mechanism.

In order to understand the process of the image decomposition unit 210, the Laplacian pyramid mechanism is briefly introduced with reference to FIG. 3.

As shown in FIG. 3, the decomposition process of the Laplacian pyramid mechanism comprises two stages. The first stage involves constructing a Gaussian pyramid. Starting from the original image G(0), subsequent images G(1) through G(n) (n is equal to 3 in the example of FIG. 3, but it is not limited hereto.) are generated by applying Gaussian filtering and downsampling at progressively lower resolutions. The image of a certain layer of Gaussian pyramid is a downsampled version of the image of its previous layer. For instance, G(1) is the downsampled version of G(0), G(2) is the downsampled version of G(1), and so on.

The second stage involves constructing the Laplacian pyramid. Starting from the top layer of the Gaussian pyramid, the image of the Gaussian pyramid is upsampled to match the resolution of its previous layer. The upsampled image is then subtracted from the corresponding image in the Gaussian pyramid to obtain the image of the corresponding layer of the Laplacian pyramid. For example, the first layer of the Laplacian pyramid L(0) is obtained by subtracting the upsampled version of G(1) from G(0). The second layer L(1) is similarly obtained by subtracting the upsampled version of G(2) from G(1), and so on. The image L(n) at the top layer of the Laplacian pyramid is simply the same as the image G(n) at the top layer of the Gaussian pyramid.

FIG. 4 is a diagram illustrating the example image components obtained by the image decomposition unit according to the present disclosure.

Referring to FIG. 4, the image decomposition unit 210 may decompose the original image 10 into a series of components at different resolution scales according to the Laplacian pyramid mechanism as shown in FIG. 3. For simplicity, in the example of the present disclosure, the original image 10 is decomposed into four image components at different resolution scales, but it should be understood that the original image 10 can also be decomposed into other numbers of image components. As shown in FIG. 4, the four image components comprises the first high-frequency component L0, the second high-frequency component L1, the third high-frequency component L2, and the low-frequency component L3 in descending order of resolution scale.

The high-frequency components, L0, L1 and L2 primarily capture the fine details of the original image 10, such as edges, textures, and sharp transitions. They may highlight areas of the original image 10 where pixel values change rapidly, representing the intricate patterns and fine structures within the original image 10.

The low-frequency component L3 primarily holds the broader, smoother details of the original image 10, such as large shapes, general color distribution, and smooth gradients. It represents the overall structure of the original image 10, comprising the coarse features, global illumination, and regions where intensity changes gradually over a larger area. It encapsulates the fundamental layout of the original image 10 while omitting finer textures and high-contrast details.

Thus, in the embodiment of the present disclosure, by adopting the Laplacian pyramid mechanism, at least the following benefits are achieved: (1) a lightweight shading removing neural network 200 can be constructed because the Laplacian pyramid captures only the differences between successive layers of Gaussian pyramid which results in the image data to be processed, (2) the high-resolution details of the original image 10 can be better retained because the Laplacian pyramid emphasizes edges and fine details at multiple scales, making it useful for sharpening images or enhancing edges in the subsequent image processing workflow, and (3) the image features can be analyzed across various resolutions due to multi-scale nature of the Laplacian pyramid. Furthermore, in the embodiment of the present disclosure, by separately removing the shading of the low-frequency component and the high-frequency component using the low-frequency subnetwork 220 and the high-frequency subnetwork 230 respectively, at least the following benefits are achieved: (1) overall feature extraction is improved because the high-frequency subnetwork focuses on fine details, while the low-frequency subnetwork focuses on global structure and large-scale features, (2) computational complexity is reduced because the separate subnetworks for different frequency components reduce parameter redundancy, (3) learning efficiency is improved as the separate subnetworks focus on different frequency components, accelerating convergence and reducing training time, (4) the robustness of the shading removing neural network 200 is enhanced because the high-frequency subnetwork 220 can better handle the noise, while the low-frequency subnetwork 230 can better stabilize the global structure extraction.

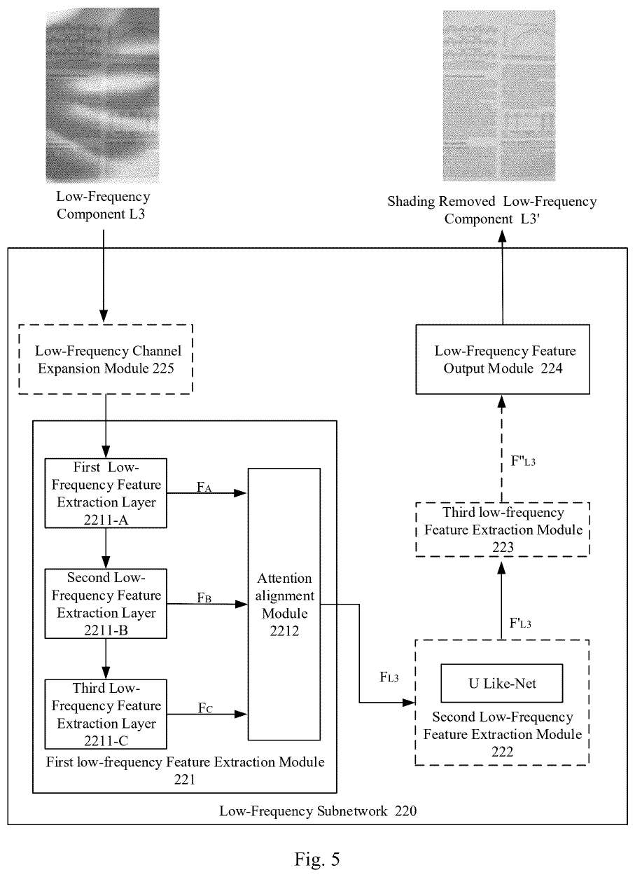

FIG. 5 is a diagram illustrating an exemplary architecture of a low frequency sub-network 220 according to an embodiment of the present disclosure. Modules represented by dashed boxes in FIG. 5 are optional modules.

Referring to FIG. 5, the low-frequency subnetwork 220 may receive the low-frequency component L3 and remove the shading of the low-frequency component L3 to output the shading removed low-frequency component L3′.

In an embodiment of the present disclosure, the low-frequency subnetwork 220 may comprise a first low-frequency feature extraction module 221 and low-frequency feature output module 224. The first low-frequency feature extraction module 221 may comprise a plurality of cascaded low-frequency feature extraction layers 2211 and an attention alignment module 2212. Each of the plurality of cascaded low-frequency feature extraction layers 2211 may determine its respective output axial feature representation F_{A}, F_{B} and F_{C} using axial attention mechanism and output it to the attention alignment module 2212.

The initial axial attention mechanism is a variation of the standard self-attention mechanism. In standard self-attention, attention is computed across the entire two dimensional (2D) grid of an image, resulting in quadratic complexity with respect to the number of pixels, making it computationally expensive for large images. The initial axial attention mechanism reduces this complexity by decomposing 2D self-attention into one dimensional 1D attention operations: row-wise attention and column-wise attention. The developed axial attention mechanism is extended to three dimensions (3D) operations: the height-wise attention, the width-wise attention, and depth-wise or time-wise attention.

In an example of the present disclosure, the plurality of cascaded low-frequency feature extraction layers may comprise first low-frequency feature extraction layer 2211-A and second low-frequency feature extraction layer 2211-B. The first low-frequency feature extraction layers 2211-A may extract the feature of the low-frequency component L3 according to height-wise attention and output the axial feature representation F_{A}. The second low-frequency feature extraction layers 2211-B may extract the feature of the low-frequency component L3 according to width-wise attention and output the axial feature representation F_{B}.

In another example of the present disclosure, the plurality of cascaded low-frequency feature extraction layers may further comprise the third low-frequency feature extraction layer 2211-C which may extract the feature of the low-frequency component L3 according to depth-wise attention and output the axial feature representation F_{C}. This structure, formed by connecting three low-frequency feature extraction layers 2211-A, 2211-B and 2211-C in series, can capture different features of the low-frequency component L3 and relationships among these features, allowing the first low-frequency feature extraction module 221 to learn information of the the feature at different levels, thereby improving the expressiveness of the entire shading removing neural network 200.

The plurality of low-frequency feature extraction layers are cascaded. That is, the input data of the second and third low-frequency feature extraction layers 2211-B and 2211-C is the axial feature representation output by their previous low-frequency feature extraction layer 2211-A and 2211-B, respectively. The input data of the first low-frequency feature extraction layer 2211-A is the low-frequency component L3.

The first, second and third low-frequency feature extraction layers 2211-A, 2211-B and 2211-C may be constructed as the same structure, such as the Transformer or CNN (Convolutional Neural Network).

Thus, in the embodiment of the present disclosure, by extracting the feature of the low-frequency component L3 according to axial attention mechanism, at least the following benefits are achieved: (1) the computational complexity is further reduced because the attention to be focused on is reduced from the 2D level to the 1D level, so that the shading removing neural network 200 can be deployed on the image capturing devices whose computational resources and/or storage resources are limited; (2) the richer features are extracted because the axial attention operates independently in each dimension and thus can flexibly capture specific features in different dimensions and is suitable for tasks that require analysis of information in multiple dimensions.

Referring to FIG. 5, the attention alignment module 2212 may fuse the output axial feature representations of all the plurality of low-frequency feature extraction layers using the axial attention mechanism to generate a first feature representation F_{L3} of the low-frequency component L3. The low-frequency feature output module 226 is configured to generate the shading removed low-frequency component L3′ based on first feature representation F_{L3} of the low-frequency component L3. It should be understood that the “based on” here includes “indirectly based on” and “directly based on”. The “directly based on” means that first feature representation F_{L3} of the low-frequency component L3 can be output as an input of the low-frequency feature output module 226. The “indirectly based on” means that the first feature representation F_{L3} of the low-frequency component L3 can be further processed before being input to the low-frequency feature output module 226. For example, as described hereinafter, the first feature representation F_{L3} can be further extracted to generate a second feature representation F′_{L3} or even a third feature representation F″_{L3} of the low-frequency component L3, and the second feature representation F′_{L3} or even the third feature representation F″_{L3} can be output as the input to the low-frequency feature output module 226.

For example, in the example in which the plurality of cascaded low-frequency feature extraction layers comprise first low-frequency feature extraction layer 2211-A and second low-frequency feature extraction layer 2211-B, the attention alignment module 2212 may generate the first feature representation F_{L3} by fusing the axial feature representations F_{A} and F_{B}. In the example in which the plurality of cascaded low-frequency feature extraction layers comprise first low-frequency feature extraction layer 2211-A, the second low-frequency feature extraction layer 2211-B and the third low-frequency feature extraction layer 2211-C, the attention alignment module 2212 may generate the first feature representation F_{L3} by fusing the axial feature representations F_{A}, F_{B} and F_{C}.

Thus, in the embodiment of the present disclosure, by fusing the axil feature representations of the low-frequency component L3, the features associated with respective attentions are integrated, and the global and local details of the low-frequency component L3 are combined. This can result in the first feature representation F_{L3} fully capturing the details of the low-frequency component L3.

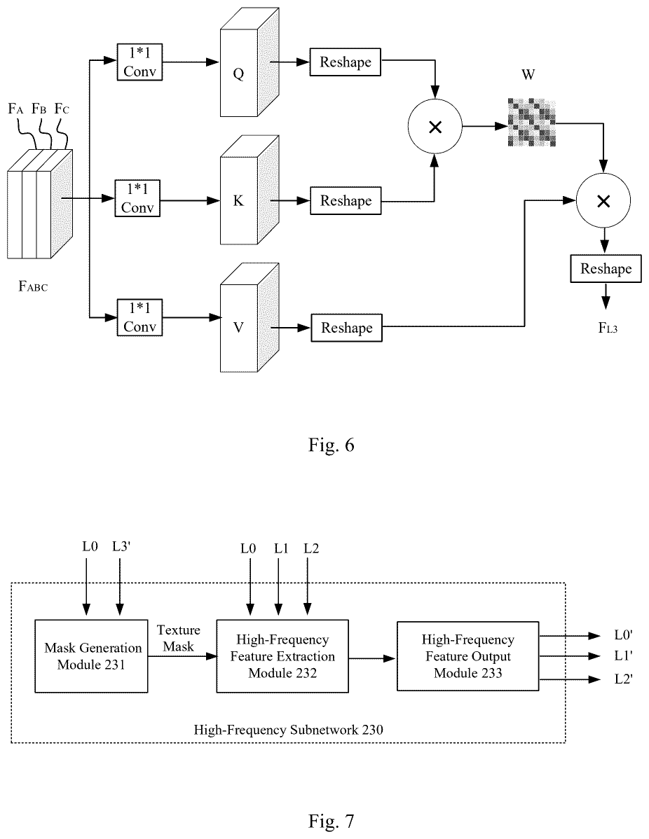

FIG. 6 is a diagram illustrating an exemplary workflow of the attention alignment module according to an embodiment of the present disclosure.

Referring to FIG. 6, the workflow of the attention alignment module 2212 used for generating the first feature representation F_{L3} may comprise the following steps. At the first step, the attention alignment module 2212 may concatenate the output axial feature representations F_{A}, F_{B}, F_{C} of the first to third low-frequency feature extraction layers 2211-A, 2211-B and 2211-C to form a feature matrix F_{ABC}. At the second step, the attention alignment module 2212 may generate the Query matrix Q, the Key matrix K and the Value matrix V corresponding to the feature matrix F_{ABC}. For example, the attention alignment module 2212 may project the feature matrix F_{ABC} to the Query matrix Q, the Key matrix K and the Value matrix V by applying three separate 1×1 convolution layers to the feature matrix F_{ABC}, each with different learnable weights. At the third step, the attention alignment module 2212 may generate an attention weight matrix W based on the Query matrix Q and the Key matrix K. At the fourth step, the attention alignment module 2212 may generate the first feature representation F_{L3} of the low-frequency component L3 by multiplying the attention weight matrix W and the Value matrix V. The method of implementing of the foregoing four steps is well known and the details for this step are omitted herein for conciseness. The function of the reshape boxes shown in FIG. 6 is to adjust the shape of the corresponding matrix so that the matrix multiplication can be performed effectively.

Referring back to FIG. 5, in another embodiment of the present disclosure, the low-frequency subnetwork 220 may further comprise a second low-frequency feature extraction module 223. The second low-frequency feature extraction module 222 may be built as a U-Net network and may generate a second feature representation F′_{L3} of the low-frequency component L3 based on first feature representation F_{L3} of the low-frequency component L3. In this case, instead of the first feature representation F_{L3} of the low-frequency component L3, the low-frequency feature output module 226 may generate the shading removed low-frequency component L3′ based on the second feature representation F′_{L3} of the low-frequency component L3. It should be understood that the “based on” here includes “indirectly based on” and “directly based on”. The “directly based on” means that second feature representation F′_{L3} of the low-frequency component L3 can be output as an input of the low-frequency feature output module 226. The “indirectly based on” means that the second feature representation F′_{L3} of the low-frequency component L3 may be further processed before being input to the low-frequency feature output module 226. For example, as described hereinafter, the second feature representation F′_{L3} can be further extracted to generate a third feature representation F″_{L3} of the low-frequency component L3 and the third feature representation F″_{L3} can be output as the input to the low-frequency feature output module 226.

As well known, the uniqueness of the U-Net network lies in its symmetrical U-shaped structure which comprises a downsampling path and an upsampling path, and the use of skip connections. The symmetrical U-shaped structure may enable the second feature representation F′_{L3} of the low-frequency component L3 capture more refined and nuanced low-frequency features than the first feature representation F_{L3} of the low-frequency component L3. The use of skip connections may enable the the second feature representation F′_{L3} of the low-frequency component L3 better maintain the original spatial layout and boundaries of the low-frequency components L3 than the first feature representation F_{L3} of the low-frequency component L3.

Thus, by adopting the second low-frequency feature extraction module 222, the accuracy of the shading removed low-frequency component L3′ generated based on the second feature representation F′_{L3} of the low-frequency component L3 is higher than that generated based on the first feature representation F′_{L3} of the low-frequency component L3.

Referring to FIG. 5, in yet another embodiment of the present disclosure, the low-frequency subnetwork 220 may further comprise a third low-frequency feature extraction module 224.

The third low-frequency feature extraction 223 may be constructed as same as the first low-frequency feature extraction 221 and configured to generate a third feature representation F″_{L3} of the low-frequency component L3 based on the second feature representation F′_{L3} of the low-frequency component L3. That is, the third low-frequency feature extraction 223 may receive the second feature representation F′_{L3} of the low-frequency component L3 and further use a plurality of cascaded low-frequency feature extraction layers and attention alignment module to obtain the third feature representation F″_{L3} of the low-frequency component L3. The process by which the third low-frequency feature extraction 223 generates the the third feature representation F″_{L3} of the low-frequency component L3 is similar to the process by which the first low-frequency encoder 221 generates the first feature representation F_{L3} of the low-frequency component L3 and thus the details for this process are omitted herein for conciseness.

In this embodiment, the low-frequency feature output module 224 may generate the shading removed low-frequency component L3′ based on the third feature representation F″_{L3} of the low-frequency component L3.

The low-frequency feature output module 224 may be constructed as a common convolution layer or a separable convolution layer, the convolution layer of which may be 1×1 or 3×3 or other size depending on the demand.

Thus, by further extracting the features of low-frequency component L3, richer features can be captured and therefore the accuracy of the shading removed low-frequency component L3′ generated based on the third feature representation F″L3 of the low-frequency component L3 is higher than that generated based on the second feature representation F′L3 of the low-frequency component L3.

Referring to FIG. 5, in yet another embodiment of the present disclosure, the low-frequency subnetwork 220 may further comprise a low-frequency channel expansion module 225.

The channel expansion module 225 may increase the number of channels of the low frequency component L3 before it is input to the first low-frequency feature extraction module 221. For example, the initial number of channels of the original image 10 is 3 (e.g., the red, green and blue channels) and thus the initial number of channels of the low frequency component L3 is also 3. The channel expansion module 225 may increase the number of channels of the low frequency component L3 up to, for example, 64 channels, 128 channels, and so on.

The channel expansion module 225 may be constructed as a common convolution layer or a separable convolution layer. The convolution kernel of the convolution layer may be 1×1 or 3×3 or other sizes as required. A Squeeze-and-Excitation (SE) module may be added to the channel expansion module 225 to achieve a better channel expansion effect and less computation. Since the low-frequency feature output module 224 may also be constructed as a common convolution layer or a separable convolution layer, the number of channels of the shading removed low-frequency component L3′ may be restored by the low-frequency feature output module 224 as the initial number of channels of the low-frequency component L3.

Thus, by increasing the number of channels of the low-frequency component L3 before performing feature extraction on it, the broader, smoother details in the low frequency component L3 is better recognized, thereby the accuracy of the shading removed low-frequency component L3′ is improved.

FIG. 7 is a diagram illustrating an exemplary architecture of a high-frequency subnetwork 230 according to an embodiment of the present disclosure.

Referring to FIG. 7, the high-frequency subnetwork 230 may comprise a mask generation module 231, a high-frequency feature extraction module 232 and a high-frequency feature output module 233.

The mask generation module 231 may generate a texture mask based on the shading removed low-frequency component L3′ and the first high-frequency component L0. For each of the set of high-frequency components L0, L1, L2, the high-frequency feature extraction module 232 may generate the feature representation F_{L0}/F_{L1}/F_{L2} of the high-frequency component L0/L1/L2 based on the texture mask and the high-frequency component L0/L1/L2. For each of the set of high-frequency components L0, L1, L2, the high-frequency feature output module 233 may generate the shading removed high-frequency component L0′/L1′/L2′ corresponding to the high-frequency component based on the feature representation F_{L0}/F_{L1}/F_{L2} of the high-frequency component L0/L1/L2.

Since the low-frequency component L3 contains the main structure or contours of the original image 10, while the first high-frequency component L0 contains the fine details and noise of the original image 10, the texture mask can retain the main structure of the original image 10 without being affected by the high-frequency noise and can therefore be stable.

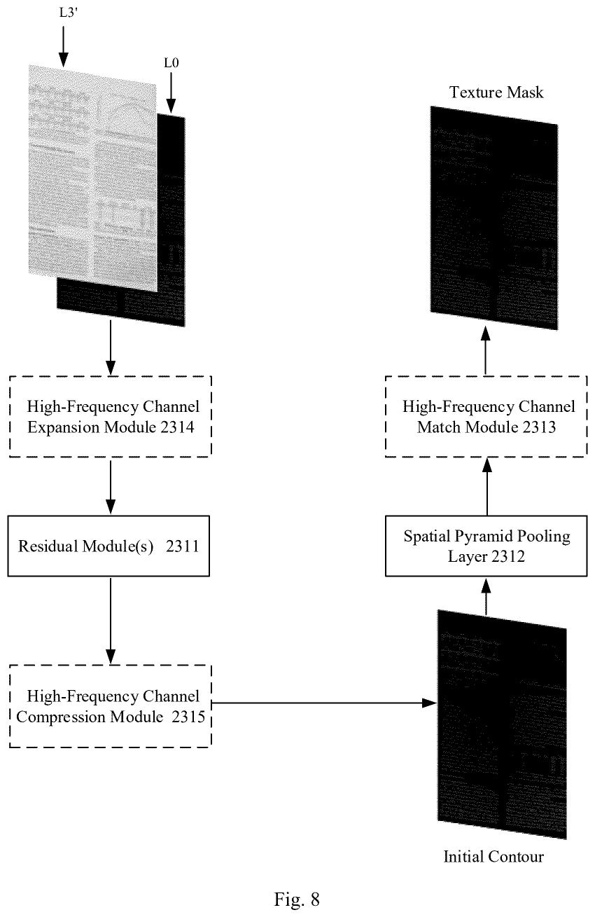

FIG. 8 is a diagram illustrating an exemplary architecture of the mask generation module 231 according to an embodiment of the present disclosure.

Referring to FIG. 8, in an embodiment of the present disclosure, the mask generation module 231 may comprise one or more cascaded residual modules 2311 and a spatial pyramid pooling layer 2312. Modules represented by dashed boxes in FIG. 8 are optional modules.

The one or more cascaded residual modules 2311 may upsample the shading removed low-frequency component L3′ to make its resolution scale to be the same as the first high-frequency component L0 and then generate an initial contour of the texture mask based on the upsampled shading removed low-frequency component L3′ and the first high-frequency component L0. The spatial pyramid pooling layer 2312 may generate the texture mask based on the initial contour of the texture mask.

The combination of the one or more cascaded residual modules 231 and the spatial pyramid pooling layer 2312 can improve the stability and noise resistance of the texture mask. The residual module(s) 2311 can avoid the loss or degradation of features caused by the deepening of the network layers. The spatial pyramid pooling layer 2312 can smooth out the small fluctuations caused by noise and retain the main texture information because it can pool the initial contour of the texture mask on different scales. Therefore, the combination of the one or more cascaded residual module(s)2311 and the spatial pyramid pooling layer 2312 makes the generated texture mask more resistant to noise. That is, even if the original image 10 has noise, the generated texture mask can retain the main texture details and will not be unstable or inaccurate due to noise interference.

Still referring to FIG. 8, in another embodiment of the present disclosure, the mask generation module 231 further comprises a high-frequency channel match module 2313 that may adjust the number of channels of the texture mask to meet the requirement of the high-frequency feature extraction module 232.

Still referring to FIG. 8, in yet another embodiment of the present disclosure, the mask generation module 231 further comprises a high-frequency channel expansion module 2314 and a high-frequency channel compression module 2315. The high-frequency channel expansion module 2314 may increase the number of channels of the shading removed low-frequency component L3′ and the first high-frequency component L0 before they are input to the one or more cascaded residual modules 2311. The high-frequency channel compression module 2315 may reduce the number of channels of the initial contour of the texture mask before it is input to the spatial pyramid pooling layer 2312.

For example, the initial number of channels of both the shading removed low-frequency component L3′ and the first high-frequency component L0 is 3 (e.g., the RGB channels). The high-frequency channel expansion module 2314 may increase it up to, for example, 64 channels, 128 channels, etc. The high-frequency channel compression module 2315 may restore the number of channels of both the shading removed low-frequency component L3′ and the first high-frequency component L0 to 3.

Thus, by increasing the number of channels prior to feature extraction, the richness of the feature extraction can be improved. By restoring the number of channels after feature extraction to the initial number of channels, the computational complexity can be reduced while the feature information is retained.

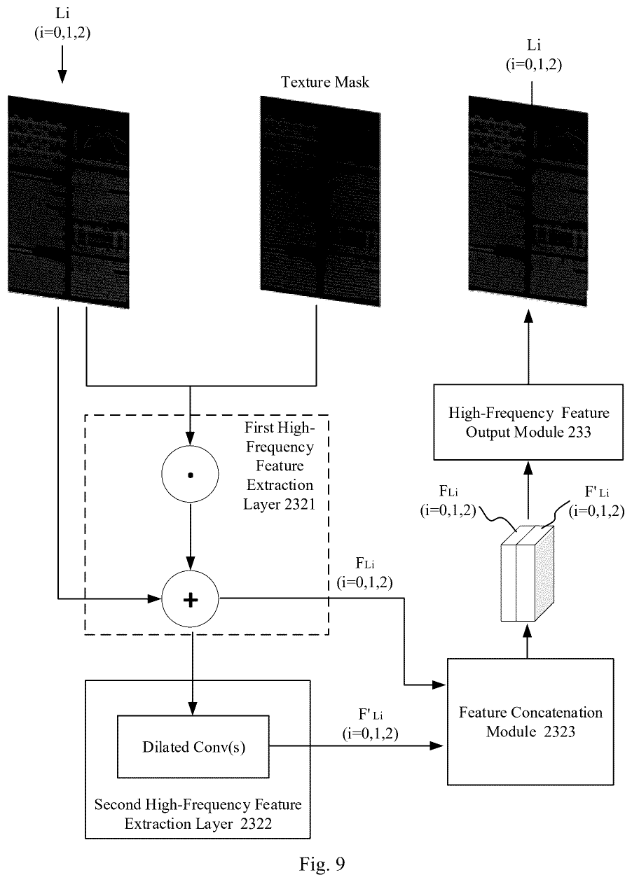

FIG. 9 is a diagram illustrating an exemplary architecture of the high-frequency feature extraction module 232 according to an embodiment of the present disclosure.

Referring to FIG. 9, in an embodiment of the present disclosure, the high-frequency feature extraction module 232 may comprise a first high-frequency feature extraction layer 2321. The set of high-frequency components L0, L1, L2 and the texture mask may be input to the first high-frequency feature extraction layer 2321. For each of the set of high-frequency components L0, L1, L2, the first high-frequency feature extraction layer 2321 may generate a first feature representation F_{L0}, F_{L1}, F_{L2} of the high-frequency component by adding the high-frequency component to the result of the dot multiplication of the high-frequency component and the texture mask.

The dot multiplication and addition operations allow the details of the high frequency component to be enhanced according to the weight distribution specified by the texture mask.

In this embodiment, the high-frequency feature output module 233 may generate the set of shading removed high-frequency components L0′, L1′, L2′ based on the first feature representation F_{L0}, F_{L1}, F_{L2} of each of the set of high-frequency components L0, L1, L2. It should be understood that the “based on” here includes “indirectly based on” and “directly based on”. The “directly based on” means that the first feature representation F_{L0}, F_{L1}, F_{L2} of each of the set of high-frequency components L0, L1, L2 can be output as an input to the high-frequency feature output module 233. The “indirectly based on” means that the first feature representation F_{L0}, F_{L1}, F_{L2} of each of the set of high-frequency components L0, L1, L2 can be further processed before being input to the high-frequency feature output module 233. For example, as described hereinafter, the first feature representation F_{L0}, F_{L1}, F_{L2} of each of the set of high-frequency components L0, L1, L2 can be further extracted to generate a second feature representation F′_{L0}, F′_{L1}, F′_{L2} of each of the set of high-frequency components L0, L1, L2, and the concatenation of the the first feature representation F_{L0}, F_{L1}, F_{L2} and a second feature representation F′_{L0}, F′_{L1}, F′_{L2} can be output as the input of the high-frequency feature output module 233.

Still referring to FIG. 9, in another embodiment of the present disclosure, the high-frequency feature extraction module 232 further comprises a second high-frequency feature extraction layer 2322 and a feature concatenation module 2323.

The first feature representation F_{L0}, F_{L1}, F_{L2} of each of the set of the high-frequency components generated by the first high-frequency feature extraction layer 2321 is input to the second high-frequency feature extraction layer 2322. For each of the set of high-frequency components L0, L1, L2, the second high-frequency feature extraction layer 2322 may generate a second feature representation F′_{L0}, F′_{L1}, F′_{L2} of the high-frequency component based on the first feature representation F_{L0}, F_{L1}, F_{L2} of the high-frequency component.

The first feature representation F_{L0}, F_{L1}, F_{L2} of each of the set of the high-frequency components are also input to the feature concatenation module 2323. For each of the set of high-frequency components L0, L1, L2, the feature concatenation module 2323 may concatenate the first feature representation F_{L0}, F_{L1}, F_{L2} and the second feature representation F′_{L0},F′_{L1},F′_{L2} of the high-frequency component to generate the concatenated feature representation of the high-frequency component.

In this embodiment, the high-frequency feature output module 2322 may generate the set of shading removed high-frequency components L0′, L1′, L2′ based on the concatenated feature representation of each of the set of high-frequency components L0, L1, L2.

The second high-frequency feature extraction layer 2322 may comprise at least one of: one or more dilated convolution layers, a U-Net network, and a combination of a spatial pyramid pooling layer and a convolution layer to increases the receptive field.

Thus, by adopting the second high-frequency feature extraction layer 2323 that increases the receptive field without increasing the number of parameters, a larger range of image information of the set of high-frequency components can be captured.

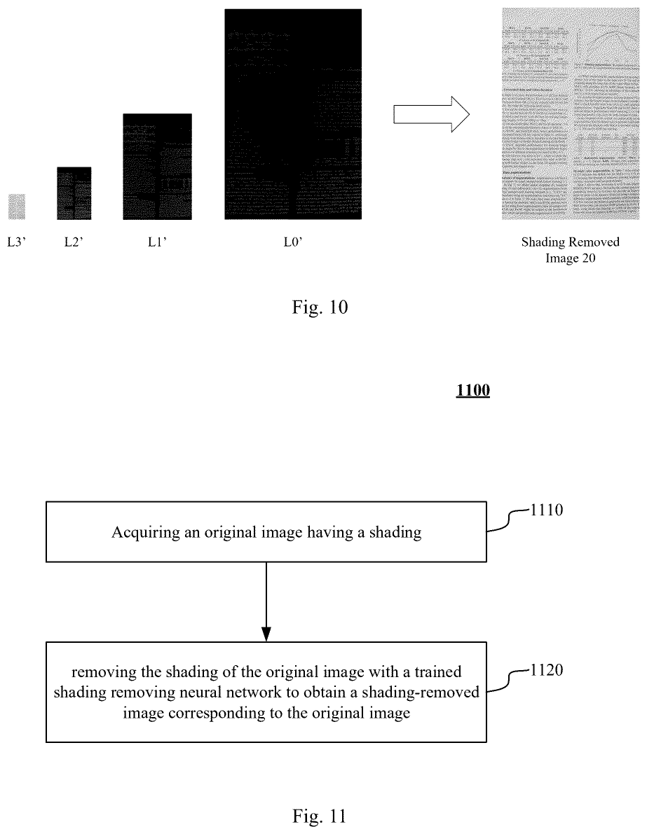

FIG. 10 is a diagram illustrating the example shading removed image obtained by the image synthesis unit according to the present disclosure.

Referring to the FIG. 10, the image synthesis unit 240 may generate the shading removed image 20 corresponding to the original image 10 by synthesizing the shading removed set of high-frequency components L0′, L1′, L2′ and the shading removed low-frequency component L3′ according to the Laplacian Pyramid Mechanism. The synthesizing operation according to the Laplacian Pyramid Mechanism is the inverse operation of the decomposing operation according to the Laplacian Pyramid Mechanism and the details for this operation are omitted herein for conciseness.

FIG. 11 is a diagram illustrating the flowchart of the method for removing shading of an image according to an embodiment of the present disclosure.

Referring to FIG. 11, the method 1100 for removing shading of an image may comprise two steps 1110 and 1120. The method can be implemented by any one of the server 110 and the terminal electric devices 120 as shown in FIG. 1. At the step 1110, an original image (e.g., the original image 10) having a shading is directly or indirectly acquired. At the step 1120, the shading of the original image is removed with a trained shading removing neural network 200 to obtain a shading removed image (e.g., the shading removed image 20) corresponding to the original image.

In an embodiment of the present disclosure, the method 1100 for removing shading of an image may further comprise a step of training the shading removing neural network 200 before the steps 1110 and 1120.

In an embodiment of the present disclosure, during the training of the shading removing neural network 200, the shading removing neural network 200 is trained end-to-end by using paired shadow/shadow-free images in the SD7K dataset. The SD7K dataset is a well-known large-scale, high-resolution dataset designed for document shading removal tasks.

In an embodiment of the present disclosure, during the training of the neural network, a weighted sum of a loss function used by the low-frequency subnetwork 220 and a loss function used by the high-frequency subnetwork 230 are used as a loss function of the shading removing neural network 200. The low-frequency subnetwork 220 may use L1 loss function and/or the Multi-Scale SSIM loss function. The high-frequency subnetwork 230 may uses L1 loss function and/or adversarial loss function.

In an embodiment of the present disclosure, during the training of the shading removing neural network 200, the low-frequency subnetwork and the high-frequency subnetwork may be optimized by an Adam optimizer to dynamically adjust the learning rate.

In an embodiment of the present disclosure, during the training of the shading removing neural network 200, early stopping and/or model weight adjustments are used to avoid overfitting to save the model with the best performance on the verification set for testing.

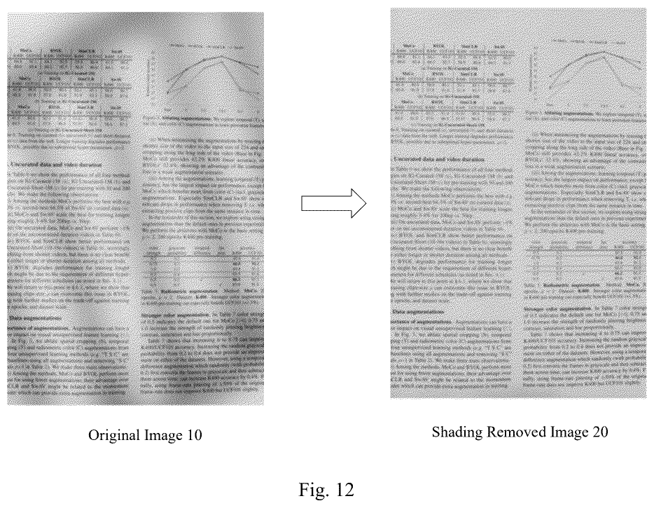

FIG. 12 is diagram illustrating a test result according to an embodiment of the present disclosure.

As shown in FIG. 12, the shading removal performance of the shading removing neural network 200 is obviously excellent.

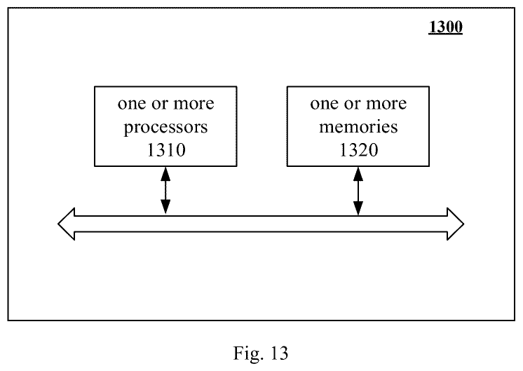

FIG. 13 is an exemplary block diagram illustrating the electronic device 1300 according to an embodiment of the present disclosure. The electronic device 1300 may be or may be included in any one of the server 110 and the terminal electric devices 120 as shown in FIG. 1.

As shown in FIG. 13, the electronic device 1300 may comprise one or more processors 1310 and one or more memories 1320. The one or more processors 1310 may be coupled with the one or more memories 1320 via a communication bus. The one or more memories 1320 have computer-executable instructions therein which, when executed by the one or more processors 1310, cause the one or more processors 1310 to perform one or more procedures of the method 1200 discussed above.

Examples of one or more processors 1310 may comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout the present disclosure.

The one or more processors 1310 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the one or more memories 1320.

The one or more memories 1320 may be a non-transitory computer-readable medium. A non-transitory computer-readable medium comprises, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

In addition, according to another embodiment of the present disclosure, a computer program product for removing shading of an image is disclosed. As an example, the computer program product comprises a computer-readable medium having program instructions embodied therewith, and the program instructions are executable by a processor. When executed, the program instructions cause the processor to perform one or more procedures of the method 200 described above.

The present disclosure may be a system, a method, and/or a computer program product at any possible technical detail level of integration. The computer program product may comprise a computer-readable storage medium having computer-readable program instructions thereon for causing a processor to carry out aspects of the present disclosure.

An expression such as “according to”, “based on”, “dependent on”, and so on as used in the disclosure does not mean “according only to”, “based only on”, or “dependent only on” unless it is explicitly otherwise stated. In other words, such expression generally means “according at least to”, “based at least on”, or “dependent at least on” in the disclosure.

The term “determining” used in the disclosure can comprise various operations. For example, regarding “determining”, calculating, computing, processing, deriving, investigating, looking up (e.g., looking up in tables, databases, or other data structures), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding “determining”, several actions can be regarded as “determining”.

The terms such as “connected”, “coupled” or any of their variants used in the disclosure refer to any connection or combination, direct or indirect, between two or more units, which can comprise the following situations: between two units that are “connected” or “coupled” with each other, there are one or more intermediate units. The coupling or connection between the units can be physical or logical, or can also be a combination of the two. As used in the disclosure, two units can be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure can be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for removing shading of an image, comprising:
acquiring an original image having shading; and
removing the shading of the original image with a trained shading removing neural network to obtain a shading removed image corresponding to the original image,
wherein the shading removing neural network comprises:
an image decomposition unit configured to decompose the original image into a low-frequency component and a set of high-frequency components using the Laplacian Pyramid Mechanism;
a low-frequency subnetwork configured to generate a shading removed low-frequency component based on the low-frequency component;
a high-frequency subnetwork configured to generate a set of shading removed high-frequency components based on the shading removed low-frequency component and the set of high-frequency components; and
an image synthesis unit configured to generate the shading removed image by synthesising the shading removed low-frequency component and the set of shading removed high-frequency components according to the Laplacian Pyramid Mechanism.

2. The method of claim 1, wherein
the low-frequency subnetwork comprises a first low-frequency feature extraction module and a low-frequency feature output module;
the first low-frequency feature extraction module comprises a plurality of cascaded low-frequency feature extraction layers and an attention alignment module; and
each of the plurality of cascaded low-frequency feature extraction layers is configured to determine its output axial feature representation using the axial attention mechanism and output it to the attention alignment module.

3. The method of claim 2, wherein:
the attention alignment module is configured to fuse the output axial feature representations of all the plurality of low-frequency feature extraction layers using the axial attention mechanism to generate a first feature representation of the low-frequency component, and
the low-frequency feature output module is configured to generate the shading removed low-frequency component based on the first feature representation of the low-frequency component.

4. The method of claim 3, wherein the attention alignment module is configured to generate the first feature representation of the low-frequency component by:
concatenating the output axial feature representations of all the plurality of low-frequency feature extraction layers to generate a feature matrix;
generating a Query matrix, a Key matrix and a Value matrix corresponding to the feature matrix;
generating an attention weight matrix based on the Query matrix and the Key matrix; and
generating the first feature representation based on the attention weight matrix and the Value matrix.

5. The method of claim 3, wherein
the low-frequency subnetwork further comprises a second low-frequency feature extraction module which is built as a U-Net network and is configured to generate a second feature representation of the low-frequency component based on the first feature representation of the low-frequency component, and
the low-frequency feature output module is configured to generate the shading removed low-frequency component based on the second feature representation of the low-frequency component.

6. The method of claim 5, the low-frequency subnetwork further comprising:
a third low-frequency feature extraction which is built as same as the first low-frequency feature extraction and configured to generate a third feature representation of the low-frequency component based on the second feature representation of the low-frequency component,
wherein the low-frequency feature output module is configured to generate the shading removed low-frequency component based on the third feature representation of the low-frequency component.

7. The method of claim 1, wherein the set of high-frequency components comprise a first high-frequency component to an n^{th} high-frequency component in descending order of resolution scale, the high-frequency subnetwork comprises:
a mask generation module configured to generate a texture mask based on the shading removed low-frequency component and the first high-frequency component;
a high-frequency feature extraction module configured to generate, for each of the set of high-frequency components, a feature representation of the high-frequency component based on the texture mask and the high-frequency component; and
a high-frequency feature output module configured to generate, for each of the set of high-frequency components, the shading removed high-frequency components corresponding to the high-frequency component based on the feature representation of high-frequency component.

8. The method of claim 7, wherein the mask generating module comprises one or more cascaded residual modules and a spatial pyramid pooling layer,
the one or more cascaded residual modules are configured to:
upsample the shading removed low-frequency component; and
generate an initial contour of the texture mask based on the upsampled shading removed low-frequency component and the first high-frequency component, and
the spatial pyramid pooling layer is configured to generate the texture mask based on the initial contour of the texture mask.

9. The method of claim 7, wherein
the high-frequency feature extraction module comprises a first high-frequency feature extraction layer; and
the first high-frequency feature extraction layer is configured to generate, for each of the set of high-frequency components, a first feature representation of the high-frequency component by adding the high-frequency component to the result of the dot multiplication of the high-frequency component and the texture mask;
the high-frequency feature output module is configured to generate, for each of the set of high-frequency components, the shading removed high-frequency components corresponding to the high-frequency component based on the first feature representation of the high-frequency components.

10. The method of claim 9, wherein:
the high-frequency feature extraction module further comprises a second high-frequency feature extraction layer and a feature concatenation module,
the second high-frequency feature extraction layer is configured to generate, for each of the set of high-frequency components, a second feature representation of the high-frequency component based on the first feature representation of the high-frequency component;
the feature concatenation module is configured to, for each of the set of high-frequency components, generate a concatenated feature representation of the high-frequency component by concatenating the first feature representation and the second feature representation of the high-frequency component;
the high-frequency feature output module is configured to generate, for each of the set of high-frequency components, the shading removed high-frequency components corresponding to the high-frequency component based on the concatenated feature representation of the high-frequency component.

11. The method of claim 10, wherein the second high-frequency feature extraction layer comprises at least one of:
one or more dilated convolution layers;
a U-Net network; and
a spatial pyramid pooling layer and a convolution layer.

12. The method of claim 1, wherein the low-frequency subnetwork further comprises:
a low-frequency channel expansion module configured to increase the number of channels of the low-frequency component before it is input to the first low-frequency feature extraction module.

13. The method of claim 8, wherein the mask generating module further comprises:
a high-frequency channel match module configured to adjust the number of channels of the texture mask to meet the requirement of the high-frequency feature extraction module.

14. The method of claim 8, wherein the mask generating module further comprises:
a high-frequency channel expansion module configured to increase the number of channels of the shading removed low-frequency component and the first high-frequency component before they are input to the one or more cascaded residual modules; and
a high-frequency channel compression module, configured to reduce the number of channels of the initial contour of the texture mask before it is input to the spatial pyramid pooling layer.

15. The method of claim 1, wherein during the training of the shading removing neural network,
a weighted sum of a loss function used by the low-frequency subnetwork and a loss function used by the high-frequency subnetwork are used as a loss function of the shading removing neural network.

16. The method of claim 1, wherein during the training of the shading removing neural network,
the low-frequency subnetwork uses L1 loss function and/or the Multi-Scale SSIM loss function; and
the high-frequency subnetwork uses L1 loss function and/or adversarial loss function.

17. The method of claim 1, wherein during the training of the shading removing neural network, the low-frequency subnetwork and the the high-frequency subnetwork are optimized by an Adam optimizer.

18. The method of claim 1, wherein during the training of the shading removing neural network, early stopping and/or model weight adjustments are used to avoid overfitting.

19. An electronic device, comprising:
one or more processors; and
one or more memories, wherein the one or more memories have computer-executable instructions therein which, when executed by the one or more processors, cause the one or more processors to perform the method of claim 1.

20. A computer program product comprising a computer readable storage medium having computer-executable instructions therein which, when executed by a processor, cause the processor to perform the method of claim 1.
